(19) United States
(12) Patent Application Publication
(10) Pub. No.: US 2019/0116385 A1
(43) Pub. Date: Apr. 18, 2019

(54) METHODS AND SYSTEMS OF LIVE ADVERTISEMENT

(71) Applicants: ABHINAV ROHATGI, Mumbai (IN); GANGA TIWARI, HYDERABAD (IN)

(72) Inventors: ABHINAV ROHATGI, Mumbai (IN); GANGA TIWARI, HYDERABAD (IN)

(21) Appl. No.: 16/090,194

(22) PCT Filed: Mar. 31, 2017
(86) PCT No.: PCT/IN2017/000069

§ 371 Date: Sep. 28, 2018

(30) Foreign Application Priority Data
Apr. 1, 2016 (IN) 201621011603

(51) Int. Cl. H04N 21/2187; G06F 21/10; G06Q 30/02

(52) U.S. Cl. CPC H04N 21/2187; G06Q 30/0277; G06Q 30/0245; G06F 21/10

(57) ABSTRACT

A method and computing system are disclosed for serving live advertisements. In one implementation the live stream server receives live audio and/or video from advertisers to be served to users on their client devices. The method may comprise providing users with items along with additional details pertaining to the items. The user can purchase the items advertised by the advertiser from within the live advertisements without leaving or redirection to other pages. The user may be enabled to perform one or more activities relative to the one or more items via the live advertisement.

### BACKGROUND

### Technical Field of Invention

The present invention is related to methods and systems for providing live advertisement.

### Description of Related Art

Over the past several years, the exponential growth of Internet has nurtured the growth of product and services purchased over the Internet. As a result, many companies are abandoning or greatly reducing traditional advertising mediums in favor of new digital advertising platforms.

Web and mobile advertising also referred to as “online” advertising harnesses the power of Internet to deliver marketing messages to customers. The current form of online advertising allows user to interact with advertisements that are made beforehand and/or in near real time to promote product and services which is a one-way communication.

TV news, sporting events, concerts, fashion shows, celebrity interviews, live cooking competitions, have long known the value of live coverage of events. Now, brands and marketers are discovering that live streaming content resonates more than on-demand content or recorded content, that stir up excitement across different age groups and categories. Live advertising removes geographic restrictions and creates relationship that might not have previously been established, potentially worldwide.

Reaching out to those customers, connecting with them via live advertisements, can reinforce the bonds they already have with a brand. Including them in a “special event” helps deliver the message that a brand is determined to stay in touch, to include a consumer in its “inner circle”. When a brand streams live content, it creates a unique experience, a one-time moment in time that becomes another form of “appointment television.”

Live advertisement has the capability of reaching thousands of potential customers around the world. But gaining real-world benefits requires the ability to convert online prospects into online customers. The more quickly you can get a potential customer to interact with an advertiser, the greater the likelihood that the potential customer becomes a customer. Prior solutions only provide a link to the website or mobile app or perhaps a feature synopsis, phone number or e-mail address in the ad or require the potential customer to go to the advertiser's website for more detailed information which makes the customer to abandon the advertisement.

### SUMMARY OF THE INVENTION

Embodiments of the present disclosure are related to systems and methods for providing a live advertisement involving audio and/or video stream from advertisers to users. In another embodiment, it provide users to participate in live advertisement including live audio and/or video stream of advertiser promoting one or more items in an online environment, with additional features providing for real-time interaction between users, and between advertiser and users. While participating in a live advertisement according to certain embodiments disclosed herein, users may chat with other users and/or post comments regarding items being advertised by advertiser.

According to various embodiments, advertiser may set up live advertisement involving live audio and/or video stream to promote and sell various items. The live advertisement may provide users with additional item resources such as by way of example including but not limited to description, specifications, images, videos, brochures, price, location of nearest outlets, documents which can be shared (for example pdf, word, ppt, excel, etc.), newsletter sign-up, social media sharing, comments which users can post and/or access when viewing the live advertisement.

In accordance with one aspect, live advertisement is a two-part advertisement. In the first part user is able to view only live and/or video stream hosted by advertiser while other sections in the advertisement like item details, image, features, etc. which are inactive or blurred or non-clickable or a time clock over the content which says the content will be visible in for example 05:12 seconds which are controlled and/or pre-defined by the advertiser and may enable other sections of the advertisement during the start or between or after the live stream of advertisement as per their choice.

In accordance with another embodiment of the system, the host interface is configured for user to perform an action initiating a purchasing process for the items being promoted by the advertiser. The live advertisement are e-commerce enabled where advertiser can specify the details, price, tax, shipping cost, etc. for each items and the user can simply click on the items and purchase the item thereby avoiding unnecessary redirection and repetitive clicks.

In another embodiment, the user has the ability to add their loyalty account and/or create a new account for the items advertised in the live advertisement during purchase.

In another embodiment, the method may further comprise providing the advertiser with the ability to limit interaction between the users. In another embodiment, the method may further comprise providing for at least one user to indicate to advertiser that the at least one user is leaving the live advertisement. The at least one user may be provided with the ability to reserve a space in live advertisement to which the at least one user may have the option of returning to after leaving the live advertisement.

In another embodiment, the method may further comprise providing for one or more users of live advertisement to view live streaming by choosing the advertisement. The method may further comprise providing for a user to share the live advertisement to a social networking web site. In another embodiment, the method may further comprise providing for advertiser of live advertisement to schedule a time at which a live, interactive online advertisement will occur. The advertiser of live advertisement may insert details and images upon which the live advertisement is displayed for other users to see at a predefined time interval during the live streaming of advertisement as per advertiser chosen interval.

In another embodiment, the method may further comprise providing for a user of live advertisement to click on details, specifications, and image of at least one item during live streaming. Information regarding the at least one items may be displayed in response to the user clicking on the details.

In another embodiment, the method may further comprise providing for the advertiser to remove a user viewing live advertisement during live streaming. The advertiser may also prevent users of live advertisement from entering the live streaming.

In another embodiment, the advertiser may record a transcript of the live streaming. Users of live advertisement may access the transcript through an interface at a pre-defined time during and/or after the live streaming has been started.

In accordance with another aspect, there is provided a system for administering a live, advertisement. The system comprises advertiser device including a display configured to present a web page to a user, a camera configured to capture a live audio and/or video stream of an advertiser promoting an item, and a computer server configured to transmit the live audio and/or video stream through a network to be displayed on the web page.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1 is a high-level block diagram of a computing environment according to one embodiment.

FIG. 2 depicts an example block diagram of the components of environment that generates and controls live advertisements.

FIG. 3 is a high-level block diagram illustrating modules within an advertiser.

FIG. 4A is an exemplary live advertisement before the start of the live streaming.

FIG. 4B shows a live advertisement with details during live streaming.

FIG. 5A-C shows an exemplary live advertisement with third party links.

FIG. 6 is a flow diagram of one embodiment of a method for managing and accounting live advertisement.

FIG. 7 is a block diagram of one embodiment of a computer system.

### DETAILED DESCRIPTION OF THE DRAWINGS

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

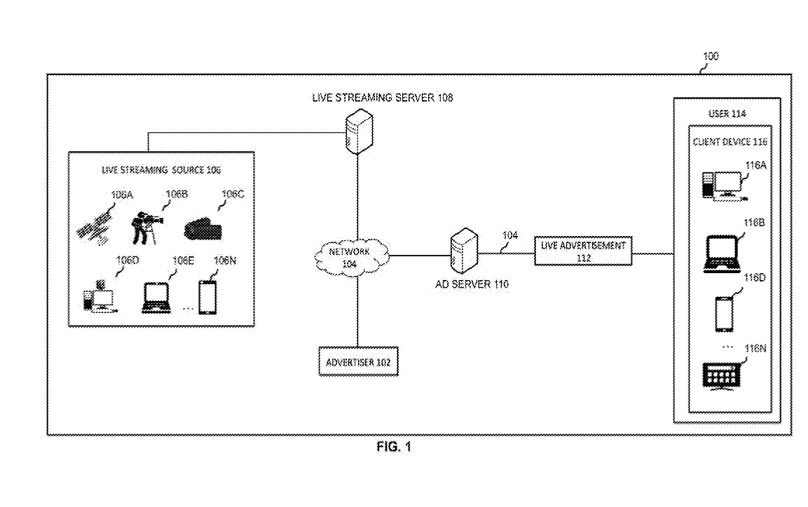

FIG. 1 depicts an exemplary system 100 for live-streaming advertisement. As shown, system 100 may include advertiser 102, a network 104, a live streaming source 106, a live streaming server 108, an ad server 110, live advertisement 112, user 114 and client devices 116. The network 104 represents communication pathways between advertiser 102, live streaming server 108, ad server 110, live advertisement 112 and client devices 114. The communication network 104 which can comprise any combination of wired and/or wireless links; any combination of one or more types of networks by way of example including but not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), WiMax, Multihop relay networks, LiFi (Light Fidelity), Femtocells, Wireless USB and ultrawideband, Unified communications, LTE-A, Miracast, 802.11ac WLAN, WiGig, WirelessHD, HomePlug AV2, MHL (Mobile High-Definition Link), G.hn (Gigabit Home Networking), MOCA 2.0, Global System for Mobile Communications (GSM), Personal Communications Service (PCS), Digital Advanced Mobile Phone Service (D-Amps), Bluetooth, Wi-Fi, Fixed Wireless Data, UMTS W-CDMA, 2G, GPRS, HSPA+, 4G networks, 5G networks, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols. The network uses standard communications technologies and/or protocols and/or utilize any combination of transmission techniques and protocols. The data exchanged over the communication network 104 can be may be written in any combination of technologies and/or formats by way of example including but not limited to hypertext markup language (HTML), extensible markup language (XML), java script object notation (JSON) along with one or more programming languages which can be by way of example including but not limited to ASP, .NET, C, C#, C++, Java, Perl, PHP, Ruby, Python, etc. The communication network 104 can have all or some of links can be encrypted using conventional encryption technologies such as the secure sockets layer (SSL), Secure HTTP and/or virtual private networks (VPNs).

The advertiser 102 is an entity that advertises items through live advertisement by a web page and/or other application installed by users 112 on their client device 114. Advertiser is by way of example including but not limited to content inventory providers, advertising networks, video ad networks, media planning companies, multi channel ad networks, cross channel ad networks, affiliate ad networks, digital ad agencies, search engines, content providers, content inventory buyers, advertising agency, business entity, corporations and a lone individual, etc. While only one advertiser 102 is shown in FIG. 1, embodiments of the environment 100 can have thousands of different advertisers. Only one advertiser 102 is shown for purposes of clarity.

The live streaming servers 108 acquire video from the live-stream source 106. Live stream source 106 A-N by way of example including but not limited to, a communications satellite, a live broadcast camera, recording camera, desktop computer, a computer cluster, or portable devices including, a notebook, a laptop computer, a handheld computer, a palmtop computer, a mobile phone, a cell phone, a PDA, a smart phone which can have and/or any combination of operating system including but not limited to like—Android® OS, Apple® iOS, Windows® Phone, WiFi phones, foldable display phones and e-paper mobile phones, open source cell phones, centralized storage cell phones, cloud storage cell phones, cover headsets, heads-up displays, smart watch, 3D glasses, virtual reality headsets, game consoles, car audio systems with camera, Kiosks, helmet mounted display, a TV but not limited to LCD, Plasma, LED, 3D, Smart TV, Ultra HD, set top boxes, streaming devices, head-mounted display, scanned-beam display, wearable computer such as mobile enabled watches, etc.

The live streaming servers 108 may use any combination of hardware and/or software modules to implement live streaming protocols by way of example including but not limited to Adobe HDS, Apple HLS, Microsoft Smooth Streaming, MPEG-DASH streaming, Adobe RTMP, HTTP Live Streaming, RTSP (Real-time Streaming Protocol), RTP (Real-time Transport Protocol), RTP Control Protocol (RTCP), UDP (User Datagram Protocol), TCP (Transmission Control Protocol), IP Multicast, PIM (Protocol Independent Multicast), P2P (Peer-to-peer), HTML5 Streaming, Adaptive bitrate streaming (ABR), etc.

The live-streaming server 108 streams live advertisement to ad server 110 using network 104. The live streaming server 108 and ad server 110 can be running an operating system by way of example including but not limiting to Linux, Mac OS X, Solaris, Unix, Ubuntu, FreeBSD, Windows Server, etc. or variants thereof. Although one server is shown for live-streaming server 108 and ad server 110 in FIG. 1 there can be any number of servers added in the environment. The ad server 110 receives live streaming from streaming server 108 and provides live advertisement 112 to user 114 on client device 116 A-N.

In one embodiment advertiser 102 can show live advertisement 112 for TV shows by way of example Star Sports® is showing ICC® World Cup LIVE it can place live advertisement 112 which show one minute of live match to user 114 and then during the live play of streaming video and/or audio prompt the user 114 to switch to Star Sports Channel to watch the match live and/or prompt the user 114 to open Hotstar® App and continue enjoying the live match. In one embodiment live advertisement 112 may contain a redirection link or mobile deep linking in live advertisement 112 to advertiser 102 website or landing page or third party website or advertiser mobile app which by way of example including but not limited to showing channel numbers based on different set top box brands, click here to watch the match live, to know more click here, a tab and/or icon indication, etc. in live advertisement 112. When a user 114 clicks on the redirection link or mobile deep linking link they may be redirected to advertiser 102 website or landing page or third party website or advertiser mobile app. Some advertiser 102 may have live advertisement 112 which may use mobile deep linking by checking if user 114 does not have advertiser 102 mobile app installed on mobile phone it will ask user 114 to first download the app and once downloaded it will open the specific page advertised and if user 114 has advertiser 102 mobile app installed on mobile phone it will open the specific page in the mobile app using client device 116 for which the live advertisement 112 was intended.

In one embodiment advertiser 102 can show real time live advertisement 112 for events for example during Hyundai® is unveiling its new Hyundai® i30 Grand at Frankfurt Motor Show Hyundai® and it may show live advertisement 112 of car launch through live streaming of audio and/or video of the event. The live advertisement 112 may contain also contain by way of example including but not limited to key features, technical specifications, description, photos, 360° view of car, book a test drive, location of nearest dealers based on users current location, brochure download of car, social media sharing of advertisement, price of car, email sign-up for updates, comments section for user, number of people who have viewed and/or shared the advertisement, etc.

In one embodiment live advertisement 112 can be in the form of live event updates for example a LIVE soccer match is going between Manchester United® F.C. and Liverpool® F.C at Old Trafford stadium with Carlsberg® as the official beverage sponsor. Carlsberg® may run live advertisement 112 with one of the super fans of the day who is sponsored by Carlsberg® to watch the match and meet the players. The live advertisement 112 will contain live streaming of audio and/or video of the super fan detailing experience of watching his favorite team play and meeting the players while asking users 114 to play the super fan contest. The live advertisement 112 may also contain by way of example including but not limited to contest details, how to play, item details of the advertiser, merchandise details, option to buy the merchandise, location of nearest outlets selling the merchandise based on users current location, social media sharing of the advertisement, number of people who have viewed and/or shared the advertisement, etc.

In one embodiment live advertisement 112 can be in the form of live updates for example a sale is going on at Target® retail chain, advertiser 102 through live advertisement 112 will contain live streaming of audio and/or video to show different item categories on sale, discounts on items, etc. The advertiser 102 may also ask customers who are at the outlet to give their views on the items, experience about the sale, etc.

In one embodiment live advertisement 112 can be in the form of live promotions for example Fast & Furious 8 movie is scheduled for release in 2017, the star casts of the movie will do promotions to advertise the movie. The movie studio Universal Pictures® can use live advertisements 112 by live streaming of audio and/or video to show promotion tours, behind the scenes of the movie, live interaction with the star casts of the movie, press releases and/or music launch thereby creating more engagement and reaching to a larger audience base and creating word of mouth advertising.

In one embodiment advertiser 102 can create live advertisement 112 for webinar. The live advertisement 112 will have live streaming of audio and/or video showing live webinar. The live advertisement 112 may also contain details about the webinar session like start date and time, duration of the webinar, details and/or description of the webinar, presenter details and/or summary, literature and/or material of webinar which can be shared and/or included for user to download during and/or after webinar which may include by way of example PDF, Word files, PPT files, Excel files, ZIP documents, etc., allow user 114 to post comments during or after the webinar.

In one embodiment advertiser 102 can create live advertisement 112 for live shows, which can be by way of example including but not limited to concerts, plays, shows, etc. The live advertisement 112 will have live streaming of audio and/or video along with details about the show, duration of the show, artist's details who are performing, history of the artist, location of the show, payment option for user 114 to purchase ticket to watch live show from within the live advertisement 112 using the client device 116 A-N, etc. In another embodiment advertiser 102 can show user 114 a thirty seconds preview of the live show before asking user 114 to purchase an online ticket to continue watching the show on their client device 116 A-N though the live advertisement 112.

In one embodiment advertiser 102 can create live advertisement 112 for courses which can be by way of example including but not limited to educational courses, vocational courses, music courses, distance learning, cookery courses, hobby courses, etc. The live advertisement 112 will have live streaming of audio and/or video along with details about the courses such as by way of example including but not limited to course description and/or summary, course syllabus and/or contents and/or topics covered, course level type by way of example—beginner, intermediate, advanced, etc., benefits of the course, details of instructor or organizer, etc., FAQ's pertaining to course, tenure of course, payment option for user to purchase and study course online. In another embodiment the user can purchase course, which can be one time fee basis or pay per session or pay per use based, pay per month based, etc. In further embodiment the live advertisement 112 for courses can be used as a standalone platform to deliver courses to user 114, which can be in the form of live streaming audio and/or video through their client devices 116 A-N.

In one embodiment advertiser 102 can create live advertisement 112 for focus group study or testing study for feedback. Focus groups are one of the best ways to seek detailed feedback from customers about your products and services. The live advertisement 112 will have live streaming of audio and/or video along with details about product and/or service, questionnaire, live reviews, usability, suggestions, etc. on product and/or services and user 114 can participate using their client device 116 A-N.

In one embodiment advertiser 102 can create live advertisement 112 for launch events by way of example including but not limited to product or service or event or store or book or movie, etc. The advertiser 112 can create a live advertisement 112 which will have live streaming of audio and/or video, which launches the event to user 114, who are viewing the advertisement using their client devices 116 A-N. The live advertisement 102 is a two-part advertisement. In the first part user 114 is able to view only live streaming of audio and/or video of the launch event but has other sections in the advertisement like product and/or service details, image, features, etc. which are inactive or blurred or non-clickable or a time clock over the content which says the content will be visible in for example 05:12 seconds. In the second part of the live advertisement 112 post launch of product and/or service the live advertisement 112 may enable user 114 to view by way of example including but not limited to key features, technical specifications, description, photos, 360° view of the car, book a test drive, location of the nearest dealers based on users current location, brochure download of car, social media sharing button for the advertisement, pricing of the car, email sign-up for updates, comments section for user, number of people who have viewed and/or shared the advertisement, etc.

In one embodiment advertiser 102 can create live advertisement 112 for virtual tours, which by way of example including but not limited to factory tours, site visits, etc. For example a real estate company can run a live advertisement 112 for a specific project location house, which will have live streaming of audio and/or video. The real estate company can provide a live tour of the house, open to user 114 across different geographical locations. The real estate company representative guiding the tour can answer questions that come in from users 114. Users 114 can ask to see certain rooms again, for the representative to open the wardrobe, to show the view from the second floor window. The advertiser 102 can also include by way of example specifications, amenities, floor plans, images of the project, brochure of the project, pricing of house, etc. along with the live advertisement 112 to be viewed by user 114 using client devices 116 A-N. In another embodiment for example, a manufacturing company is giving user 114 an insider look into their company office and factories. This delivers on one of the brand's key value propositions that is transparency. Because of the raw and unscripted nature of live advertisements 112, it is a great way to prove authenticity, trust and differentiation with user 114.

In one embodiment advertiser 102 can create live advertisement 112 for interactive sessions. These interactive sessions can by way of example including but not limited to tips, or tricks or FAQ's pertaining to product and/or service, etc. The live advertisement 112 will have live streaming of audio and/or video to user 114 along with other details in the advertisement such as by way of example including but not limited to product and/or service details, description, images of the product and/or services, a link to purchase the product and/or service during the interactive session in the advertisement.

In one embodiment advertiser 102 can create live advertisements 112 for restaurants and/or hotels. The live advertisement 112 will have live streaming of audio and/or video of restaurant and/or hotel can bee seen by the user 114 before booking the table, restaurant and/or hotel detailing the facilities, features, ambience, today's special menu to user 114 through audio and/or video to user 114 and taking orders, etc. Other details, which advertiser 102 can add to live advertisement 112, are menu card, ordering of food or beverages, payment options, credit card offers available, current deals and offers running at the restaurant and/or hotel, etc.

In one embodiment advertiser 102 can create live advertisement 112 for educational institutions. The live advertisement 112 will have live streaming of audio and/or video. For example a college offering Masters In Business Administration (MBA) may post details about the courses, faculty of the college, companies that come for placements, campus facilities, etc. the advertiser 102 may schedule a live Question & Answer (Q&A) session with faculty and current students for new admission seekers to get their queries answered.

In one embodiment advertiser 102 can create live advertisement 112 for voting. These voting can by way of example including but not limited to voting and/or poll pertaining to by way of example TV shows such as Master Chef®, American Idol®, soccer match, etc. The live advertisement 112 may also have live streaming of audio and/or video and other details such as a voting questions in the form of check box selection menu system for information, radio button selection menu system for information, yes or no menu system for information, the information may prompt the user to move to the next screen, images with questions, description and/or text, etc. be individual, in part and/or combination of all, etc. The advertiser 102 can define the start time and end time of the live advertisement 112 during which only users 114 can vote.

In one embodiment advertiser 102 can create live advertisement 112 for sale. The advertiser 102 can host a live sale for items, which the advertiser 102 intends to sell. The live advertisement 112 will have live streaming of audio and/or video. The advertiser 102 can choose items that he desires to sell beforehand and/or update items during the live sale. In another embodiment the advertiser 102 can also define the total quantity of items that he intends to sell during the live sale. The live advertisement 112 can have by way of example including but not limited to title of items, specifications of items, features of items, price of items, images of items, video of items, payment options, shipping details, taxes, etc.

In one embodiment advertiser 102 can create live advertisements 112 for contests. The live advertisement 112 will have live streaming of audio and/or video with user 114 along with other details in the advertisement such as by way of example including but not limited to product and/or service contest, how to play and/or enter contest, terms and conditions of contest, images of the contest, rules of the contest, link of the contest, rewards and/or gifts to be won in contest, etc.

The client device 116 A-N can be by way of example including but not limited to, a server desktop, a desktop computer, a computer cluster, or portable devices including, a notebook, a laptop computer, a handheld computer, a palmtop computer, a mobile phone, a cell phone, a PDA, a smart phone which can have and/or any combination of operating system including but not limited to like—Android OS, iOS, Windows Phone, WiFi phones, foldable display phones and e-paper mobile phones, Open source cell phones, Centralized storage cell phones, cloud storage cell phones, cover headsets, heads-up displays, smart watch, 3D glasses, virtual reality headsets, game consoles, car audio systems, Kiosks, navigation systems, helmet mounted display, a TV but not limited to LCD, Plasma, LED, 3D, Smart TV, Ultra HD, set top boxes, streaming devices, head-mounted display, scanned-beam display, wearable computer such as mobile enabled watches, virtual and/or 3D glasses and/or any other mobile interfaces and viewing devices, etc. The client device 116 A-N may be a location-aware device that is able to determine its own location or identify location information from an external source. In another embodiment client device 116 A-N may contain software such as web browser or other application for viewing live ads from ad server 110.

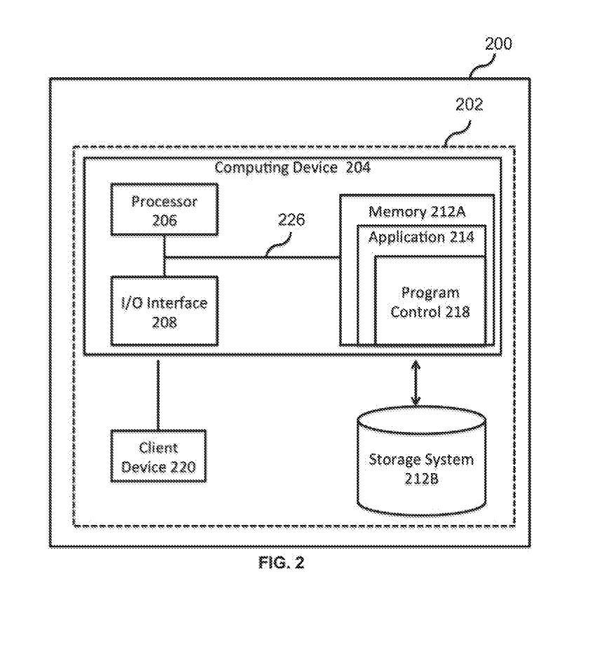

FIG. 2 shows an illustrative environment 200 for managing the processes in accordance with the invention. To this extent, the environment 200 includes a computer infrastructure 202 that can perform the processes described herein. In particular, the computer infrastructure 202 includes a computing device 204 that comprises an application 214 having a program control 218, which makes the computing device 204 operable to perform the processes described herein. For example, the computing device 204 includes a processor 206, a memory 212A, an input/output (I/O) interface 208, and a bus 226. The memory 212A can include local memory employed during actual execution of program code, bulk storage, and cache memories which provide temporary storage of at least some program code (e.g., program control 218) in order to reduce the number of times code must be retrieved from bulk storage during execution. Further, the computing device 204 is in communication with an external I/O device/resource 208 and a storage system 212B. The I/O device 220 can comprise any device that enables an individual to interact with the computing device 204 or any device that enables the computing device 204 to communicate with one or more other computing devices using any type of communications link.

The processor 206 executes computer program code (e.g., program control 218), which is stored in memory 212A and/or storage system 212B. While executing computer program code, the processor 206 can read and/or write data to/from memory 212A, storage system 212B, and/or I/O interface 208. The bus 226 provides a communications link between each of the components in the computing device 204.

The computing device 204 can comprise any general purpose computing article of manufacture capable of executing computer program code installed thereon (e.g., a personal computer, server, wireless notebook, smart phone, personal digital assistant, etc.). However, it is understood that the computing device 204 is only representative of various possible equivalent computing devices that may perform the processes described herein. To this extent, in embodiments, the functionality provided by the computing device 204 can be implemented by a computing article of manufacture that includes any combination of general and/or specific purpose hardware and/or computer program code. In each embodiment, the program code and hardware can be created using standard programming and engineering techniques, respectively. Similarly, the computer infrastructure 202 is only illustrative of various types of computer infrastructures for implementing the invention. For example, in embodiments, the computer infrastructure 202 comprises two or more computing devices (e.g., a server cluster) that communicate over any type of communications link, such as a network, a shared memory, or the like, to perform the processes described herein. Further, while performing the processes described herein, one or more computing devices in the computer infrastructure 202 can communicate with one or more other computing devices external to computer infrastructure 202 using any type of communications link.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CDROM),
an optical storage device, and/or
a transmission media such as those supporting the Internet or an intranet, or a magnetic storage device.

The computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. The storage system 22B (e.g. database) may be managed by a database management system (DBMS), for example including but not limited to, Oracle, DB2, IMS DB, NoSQL, Microsoft SQL Server, PostgreSQL, MySQL, etc. The storage system 22B can be implemented by way of example including but not limited to object-oriented technology and/or via text files, and can be managed by a distributed database management system, an object-oriented database management system (OODBMS) (e.g., ConceptBase, FastDB Main Memory Database Management System, JDO Instruments, ObjectDB, etc.), an object-relational database management system (ORDBMS) (e.g., Informix, OpenLink Virtuoso, VMDS, etc.), a file system, and/or any other convenient or known database management package. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages which can be by way of example including but not limited to ASP, .NET, C, C#, C++, Java, Perl, PHP, Ruby, Python, etc. programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network can be used as described in 202.

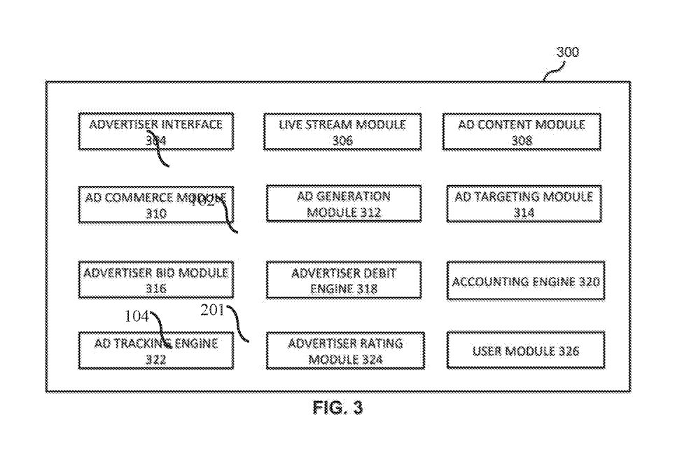

FIG. 3 is a high-level block diagram illustrating modules within an advertiser. The advertiser interface 304 is an interface to enable advertiser 102 of FIG. 1 to submit and/or create and/or interact with live advertisement 112 running on the advertising server 110. In one embodiment, advertiser interface 304 is a web page front end for updating and/or receiving advertisement content and updating and/or receiving associated bids or managing or hosting and/or creating and/or interacting live advertisement 112 via a network such as network 104 of FIG. 1.

The advertiser interface 304 is used by advertiser 102 to create or update or manage or host or reply to live advertisements which can be accessed through a browser including by way of example but not limited to Microsoft® Internet Explorer, Mozilla® Firefox, Google® Chrome, etc. In another embodiment the advertiser interface 304 can be used to provide information regarding desired users of the advertisement the total number of impressions for advertisement, estimated budget, targeted user attributes, preferences and receive information regarding available advertisement inventories, users profile and pricing details. In another embodiment data pertaining to advertiser identification, pre-payments, advertisement preferences, etc. may also be received at advertiser interface 304, and stored along with advertisement content and bids.

The live stream module 306 receives live stream from live steam source 106 to be viewed by users 114 on their client devices 116 A-N. The live stream source 106 captures the live stream and transcodes it to live stream module with formats such as by way of example MPEG-1, MPEG-2, MPEG-4, H.261, H.263, H.264, Real Video, MP3, WMV, FLV, 3GPP, WMV, MOV, FLAC, MP3, AAC, OGG, QuickTime, etc. and may dynamically segment a copy of the live stream into “chapters” for time-shifted viewing. Segments may also be used to support downloading at selectable data rates. The transcoded data is stored in a file system inside the live stream module 306 to be streamed through live streaming server 108. The live stream module 306 stores live stream in the file system for users who were unable to see the live stream after the completion of live advertisement 112.

In another respect, the live stream module 306 records data into segments, in a plurality of encodings in a plurality of formats, to support a plurality of heterogeneous client devices 114. In one embodiment, the live stream source 106 is transcoded into a plurality of different bit rate encodings, which are written into separate files in segments. In one embodiment, each bit rate encoding may be stored in a plurality of file formats. Each format is written to a separate segment file. The different bit rates may be used to support heterogeneous client devices 114 generally, as well as provide the ability for adaptive adjustment of the bandwidth required for streaming to tailor operation to changing network conditions, improving overall system performance.

An ad content module 308 stores live advertisement 112 details received from the advertiser 102. The ad content module 308 serves as a data repository from which the live advertisement 112 can be retrieved and served to users 114 on their client devices 116 A-N. In one embodiment, the advertiser 102 creates other details with respect to live advertisement 112 apart from live streaming of audio and/or video by way of example including but not limited to logo of advertiser, description of item, specification of item, image of item, video of item, brochure of item, price of item, location of nearest outlet, documents which can be shared (for example pdf, word, ppt, excel, etc.), create check boxes to questions, newsletter sign-up, comments box, advertiser social media details, etc. and associates this data with the corresponding live advertisement 112. For example, live advertisement 112 is for a new Honda® Accord car the advertiser 102 can add details by way of example key features, specifications, images, videos, 360° view of the car, test drive booking, dealers list, brochure of car, etc. in the ad content module 308 with respect to advertisement.

In one embodiment the advertiser 102 specifies in ad content module 308, maximum number of number of user 114 who can view live advertisement 112. In one embodiment the advertiser 102 specifies in ad content module 308, time interval for item details to be visible to user 114. (e.g. 2 minutes after start of live stream or 2 minutes before the end of live stream or at the start of live stream or before the start of the live stream). In one embodiment the advertiser 102 specifies in ad content module 308, e-commerce details (e.g. tax structure, delivery cost, postal code serviceability, invoicing details, etc.). In one embodiment the advertiser 102 specifies in ad content module 308, whether to allow user 114 to interact between other users.

In one embodiment advertiser 102 specifies in ad content module 308, the details (for example images, videos, wallpapers, ringtones, description, specifications, documents, etc.) that are available for user 114 to download for the given live advertisement 112.

In one embodiment advertiser 102 specifies in ad content module 308, whether to allow user 114 to leave the live advertisement and reserve a space for user 114 later to return to the live advertisement 112. In one embodiment advertiser 102 specifies in ad content module 308, whether to allow user 114 to return to advertisement after leaving the advertisement. In one embodiment the advertiser 102 specifies in ad content module 308, whether to allow user 114 to share advertisement on social media. In one embodiment the advertiser 102 specifies in ad content module 308, whether to allow user 114 to view item details pertaining to live advertisement 112 to be viewed after the end of live advertisement 112.

In another embodiment advertiser 102 specifies in ad content module 308, the serial numbering for invoice generation and/or transaction number or enrollment number for user 114 which require transactions.

In one embodiment advertiser 102 specifies in ad content module 308, rules for sign-up. For example when advertiser 102 creates a live advertisement 112 for courses the advertiser 102 may create rules for user 114 to create an account with advertiser and enter their details. In one embodiment the advertiser 102 may automatically create a sign-up and ask the user 114 to enter the details. In another embodiment the advertiser 102 may ask user to enter their existing login details with advertiser 102. The details pertaining to login attributes will be stored, are described in 326 of FIG. 3.

In one embodiment, the ad content module 308 operates like an ad template, which the advertiser 102 uses to create live advertisement 112. The ad template allows the advertiser 102 to create rich and interactive advertisement with drag and drop functionality defining advertising data by way of example layout, placement of images, text, videos, invoice format (e.g. layout and text), social media sharing, stubs for ecommerce functionality that are displayed when the advertisement is published.

Ad commerce module 310 enables advertiser 102 to support e-commerce transactions for live advertisement 112. In one embodiment, the ad commerce module 310 interacts with live advertisement 112 to facilitate purchases by user 114 through client device 116 A-N. The ad commerce module 310 stores details for example, name of the item, item id, item details, tax rates (Service Tax, VAT, etc.), delivery cost for item, postal code serviceability, invoicing and shipment tracking with respect to live advertisement 112.

Live advertisement 112 is enabled with e-commerce because a user 114 can interact directly within the live advertisement to purchase the advertised items from the advertiser 102. Through the interactive nature of live advertisement, the user 114 specifies a quantity to purchase, provides payment and delivery details, receives a final price and purchase confirmation, and/or performs other steps utilized in the transaction. In one embodiment, the live advertisement 112 interacts with the payment system built within the live advertisement platform to effect the e-commerce transactions.

An ad generation module 312 generates live advertisement 112 for advertiser 102 by combining live stream module 306 which contains live streaming of audio and/or video along with ad content module 308 which contains item details pertaining to the live advertisement 112. The ad generation module 312 shows advertiser 102 a pre-view of how the live advertisement 112 will appear to the user 114 on their client devices 116 A-N before publishing the live advertisement 112.

The advertiser 102 utilizes the ad content module 308 through the ad interface 304 to build the advertisement by adding artwork, defining behaviors, and making other alterations to customize the live advertisement 112. In addition, the advertiser 102 utilizes the ad generation module 312 to associate ad commerce module 310 with the live advertisement 112. The ad commerce module 310 are used to conduct the ecommerce transaction which include information such as the name, description, and price of the item being advertised, tax rules describing how to tax sales of the item in one or more jurisdictions, postal code serviceability, shipping cost to user, shipment tracking, etc.

The ad targeting module 314 defines targeting criteria for live advertisement 112. In one embodiment, the advertiser 102 uses the targeting criteria module 314 with parameters by way of example including but not limited to age, gender, geography, user interests, day part timings, dwell times, preferences, etc.

Advertiser bid module 316 defines a bid price that the advertiser 102 agrees to pay when the items advertised by live advertisement 112 are viewed and/or sold and/or subscribed to a user 114. In another embodiment data pertaining to advertiser identification, prepayments, advertisement preferences, etc. may also be received at advertiser interface 304, and stored along with ad content module and bids.

In one embodiment, the advertiser 102 utilizes the bid module 316 in combination with the targeting criteria module 314 to define bid prices that are paid when a user 114 has viewed and/or sold and/or subscribed to a live advertisement 112, regardless of whether the user eventually purchases the items being advertised.

Further, in one embodiment the advertiser 102 utilizes the targeting criteria module 314 and advertiser bid module 316 to define bid prices that the advertiser 102 pays when a live advertisement 112 is displayed. The advertiser 102 can make these bids based on the number of viewers who have viewed the advertisement or per user basis or based on total ad impressions or the bid for each sale of an advertised item, etc.

Advertiser debit engine 318 is responsible for charging advertiser 102 when a bid associated with an advertisement has been satisfied. In one embodiment, advertiser debit engine 318 generates and transmits an invoice to the appropriate advertiser. In another embodiment, advertiser debit engine 318 debits a prepaid advertisement account associated with the advertiser 102.

Accounting engine 320 determines that a bid for an advertisement has been satisfied, when accounting engine 320 supplies data indicating the successful bid to both the advertiser debit engine 318 and advertiser 102.

Advertisement tracking engine 322 is responsible for receiving and accumulating advertisement reports. As discussed herein, when a user 114 interacts with live advertisement 112 on client devices 116 A-N in FIG. 1, the interaction is recorded in advertisement tracking engine 322.

Advertisement reports specify a type of interaction by way of example including but not limited to click, view, navigation, form data filled by user, advertisement liked by user, advertisement shared by user, length of interaction, and quality of interaction (e.g., a “pixel time” for audio and/or visual advertisements, ambient audio and/or video influence for audio and/or video advertisement or a combination of both). Advertisement tracking engine 322 analyzes data specified in report and stores advertisement interaction results. The results are compared against corresponding advertiser bids stored in advertiser bid log 316 to determine when a bid for a live advertisement 112 has been satisfied.

An advertiser rating module 324 monitors transactions performed by the user 114 on behalf of the advertiser 102 and calculates reputation scores indicating the relative qualities of the advertiser 102. The advertiser rating module 324 receives data indicating the relative qualities of the advertiser 102. For example, an embodiment of the advertiser reputation module 324 favors advertisers that have relatively high amounts and/or volumes of viewership or likes or shares and/or transactions. These data signal that the advertiser 102 is popular. Similarly, an embodiment of the advertiser reputation module 324 measures the content quality, advertisement quality, click rates, ad relevance, audience acceptance of advertisement, abandonment rates, audience targeting, fulfillment time, refund and chargeback scores, etc.

In one embodiment, the advertiser rating module 324 provides an interface allowing users to provide feedback on their experiences with the advertiser 102. Embodiments of the advertiser rating module 324 use other and/or additional data to calculate reputation scores for the advertiser 102.

In one embodiment, the advertiser rating module 324 generates advertiser 102 reputation score into a numerical and/or graphical rating, such as assigning the advertiser 102 one through five stars, where five stars indicates the highest possible reputation. This rating is added to the live advertisement 112 in the ad generation module 312 and/or otherwise included in advertiser bid log 316 to determine the price advertiser 102 has to pay for the advertisement 112. In one embodiment, the ad generation module 312 causes advertiser 102 rating to appear on the live advertisement 112, thereby providing the user 114 with an indication of the advertiser 102 reputation.

In one embodiment, the user 114 uses the advertiser rating module 324 to give ratings to advertiser 102 by way of example including but not limited to relevancy of content, content quality, correctness of items, quality of presenter, etc.

In one embodiment, the advertiser 102 uses the advertiser rating module 324 to give ratings to user 114 who are viewing the live advertisement 112 which can be given on by way of example including but not limited to relevancy of user, frequency of user to advertiser advertisement, behavior of users during live advertisement, etc.

A user module 326 maintains accounts for user 114, allows adding of loyalty membership details and allows user 114 to create a new account with the advertiser 102. An embodiment of the user module 326 includes a web server that presents a new user with one or more web pages allowing the user 114 to create an account and fill details for example user ID & password, address, postal code, city, mobile number, date of birth, etc. and/or other identifying information to be used for subsequent login with advertiser 102. In one embodiment, the user 114 stores payment information specifying a credit and/or debit card and/or adding a mobile wallet. The payment information can include, for example, a credit card number, a cellular telephone number, and/or a gift certificate identifier. The user 114 can also enter their delivery addresses, postal code, city, etc. for quick checkout. In one embodiment, the user module 326 allows a user 114 to establish a default payment method and/or delivery address. Also, in one embodiment the user module 326 allows user 114 to add loyalty membership numbers, ID, password and/or other identifying information to allow user 114 to earn loyalty points for the respective advertiser 102 which will be credited to their loyalty account directly.

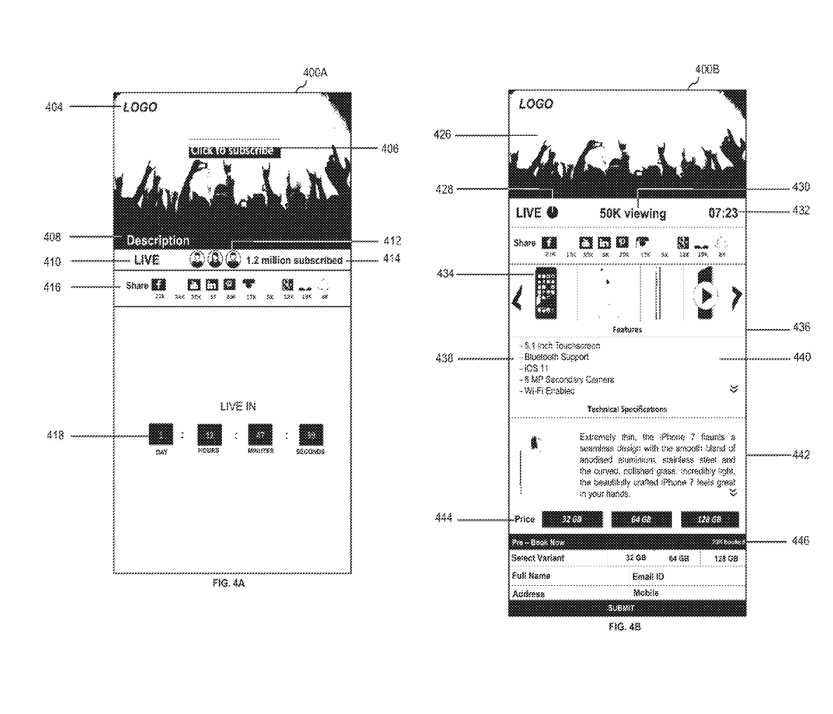

FIG. 4A is an exemplary live advertisement before the start of the live streaming. Advertiser 102 can create live advertisement 112 through advertiser interface 304 in FIG. 3 by creating advertisement through ad content module 308 such as adding logo 404 which will be visible to user 114, click to subscribe button 406 where user 114 can click to subscribe for live stream of advertisement, a short description of the live stream 408, if the event is not live it will show a cross mark to user 410, number of user 114 friends who have also subscribed for live advertisement 412, the total number of user who have subscribed for live advertisement 414, user can share live advertisement 112 on social media platforms using the share button 416, a timer 418 shows when the live advertisement 112 is available for viewing.

In one embodiment user 114 has to click on the live advertisement 112 and click on the subscribe button 406, if the live advertisement 112 has started he will be directly shown the live advertisement 112, and if the live advertisement 112 has not started it will be added to user 114 live advertisement subscription list and will be notified before the start of the live advertisement 112.

In one embodiment advertiser 102 can create and/or add social media sharing buttons 416 for the live advertisement 112 which user 114 can use to share.

In one embodiment, advertiser 102 can send invite to user 114 for live advertisement 112 who have previously viewed their live advertisement 112. In one embodiment advertiser 102 will send notification to user 114 prior to the start of the live advertisement 112. In one embodiment the advertiser 102 will be intimated if the invited user has not see the live advertisement 112.

FIG. 4B shows a live advertisement with details during live streaming. User 114 is able to view live streaming of audio and/or video by advertiser 102 in 426. The live button 428 displays an indicator dot in front of the text to show that the advertisement is live. Shows the number of user 114 who are currently watching the live advertisement 112 at 430. The timer shows elapsed time since the start of the event at 432. Advertiser 102 can design live advertisement 112 through advertiser interface 304 of FIG. 3, which can have a single or carousel images and/or videos, 3D interactive and/or rotatable images and/or videos at 434. The advertiser 102 can add different sections to live advertisement 112 with headings that detail out each section at 436. The different sections 436 can have a single or carousel picture and/or video 438, item description, features, etc. as text 440 and table format 442 for detailing different item sections, selection parameters 444 which can be by way of example including but not limited to list view, grid view, check box view or drop down view, etc. to select item and keeping track on the number of people who have performed a specific activity and displaying it at 446.

In one embodiment the method may enable user 114 to perform one or more actions relative to one or more sections via the interactive user interface. The method may include user 114 to select, view and/or submit information available in different sections made in live advertisement 112.

The live advertisement 112 may be a two part advertisement. Before the start of the live advertisement 112 the advertiser 102 may allow one or more sections 434-446 to be turned on and/or off as desired by advertiser 102. Once the live advertisement 112 has started the advertiser 102 may turn on and/or sections 434-446 for users 114 as desired by advertiser 102.

In one embodiment live advertisement 112 may allow user 114 to view and/or receive additional information such as by way of example item images and/or videos, email, download link, subscription plans, price, packages, etc. In one embodiment user 114 can purchase the advertised item in live advertisement 112 through ad commerce 310 as detailed in FIG. 3 which is built in live advertisement 112.

In one embodiment user 114 may perform various activities on items in live advertisement 112 within the displayed list for example through navigation mechanisms, such as gesture scrolling via a touch screen user interface. The list of items may include a graphical list, a grid list, a text-based list, and/or a combined graphical/text-based list of items or any combination thereof as desired by advertiser 102.

In some embodiments, live advertisement 112 may allow user 114 to purchase at least one of the items included in the live advertisement 112 from advertiser 102. For example, one or more of the items displayed within the live advertisement 112 may include an option to buy the advertised item (such as a link, button, etc.). In response to selecting the option to buy the item may be added to an electronic shopping cart associated with the user 114, and/or a transaction to purchase the item may be completed through ad commerce 310 as detailed in FIG. 3 which is built in live advertisement 112.

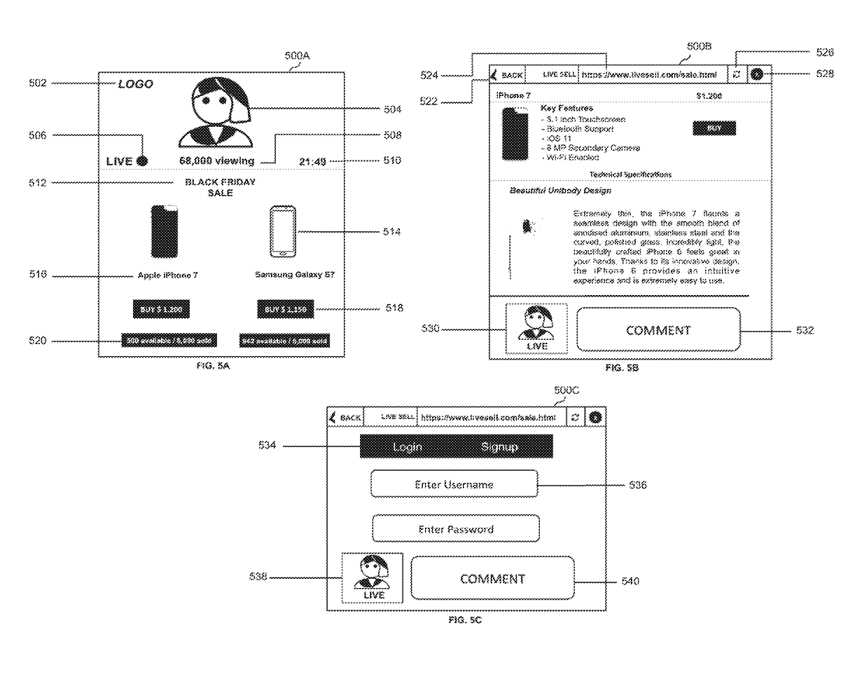

Referring to FIG. 5A an advertiser 102 can create live advertisement 112 through advertiser interface 304 of FIG. 3 by adding details such as logo 502 which will be visible to user 114. User 114 is able to view live streaming of audio and/or video by advertiser 102 at 504. The live button 506 displays an indicator dot in front of the text to show that the advertisement is live. Shows the number of user 114 who are currently watching the live advertisement 112 at 508. The timer shows elapsed time since the start of the event at 510. Advertiser 102 can add title 512 for live advertisement 112. Item photos and/or videos at 514 and title for item at 516. Price for item at 518 and at 520 it shows the number of devices that have been sold and/or available for user 114. As shown in FIG. 5A there are only two mobile phones at 516 there can be any number of mobile phones and/or items by advertiser 102.

When the user clicks on any desired phone he wishes to purchase he is taken to the next navigation screen inside the live advertisement 112 and/or redirected to advertiser 102 website and/or third party link for purchase of item. The redirection link opens in an embedded web browser and/or an in app browser as shown in FIG. 5B. It shows user 114 a browser address bar 524 with advertiser 102 website address and a page refresh button 526. At 528 user 114 can close the embedded web browser and/or in app browser as and when needed. The link does not take the user to a new tab and/or page it opens a new page on the existing page for the user to view advertiser website and/or third party link and when user 114 wants to return to the main page he can click on 522. User 114 is able to view live streaming of audio and/or video by advertiser 102 at 530 while browsing item details in the next navigation screen inside the live advertisement 112 and/or the embedded web browser and/or in app browser. At 532 the user 114 can write comments to the advertiser 102 and ask any questions and/or queries while seeing the items.

The next navigation screen inside the live advertisement 112 and/or embedded web browser and/or an in app browser takes the user 114 to the next page of the advertiser 102 page and/or website as shown in FIG. 5C where user can enter login and/or signup details at 534 and username and password at 536 to complete the transaction as per advertiser rules. User 114 is able to view live streaming of audio and/or video by advertiser 102 at 538 while browsing item details through the next navigation screen inside the live advertisement 112 and/or embedded web browser and/or in app browser. The comment box 540 is adjustable with drag and drop functionality for user 114 and a user can minimize the comment box to perform actions.

In one embodiment the advertiser 102 may include multiple items 514 in the live advertisement 112 which can include multiple photos and/or videos. In some embodiments, live advertisement 112 may allow user 114 to purchase at least one of the items included in the live advertisement 112 from advertiser 102. For example, one or more of the items displayed within the live advertisement 112 may include an option to buy the advertised item in live advertisement 112 (such as a link, button, etc.).

In some embodiments purchasing an item in live advertisement 112 may require the user 114 to provide financial and/or shipping information. In some embodiments, if the user 114 has an existing account with the selected advertiser 102, the transaction may be processed utilizing financial and delivery information associated with the user 114 account for the selected advertiser 102.

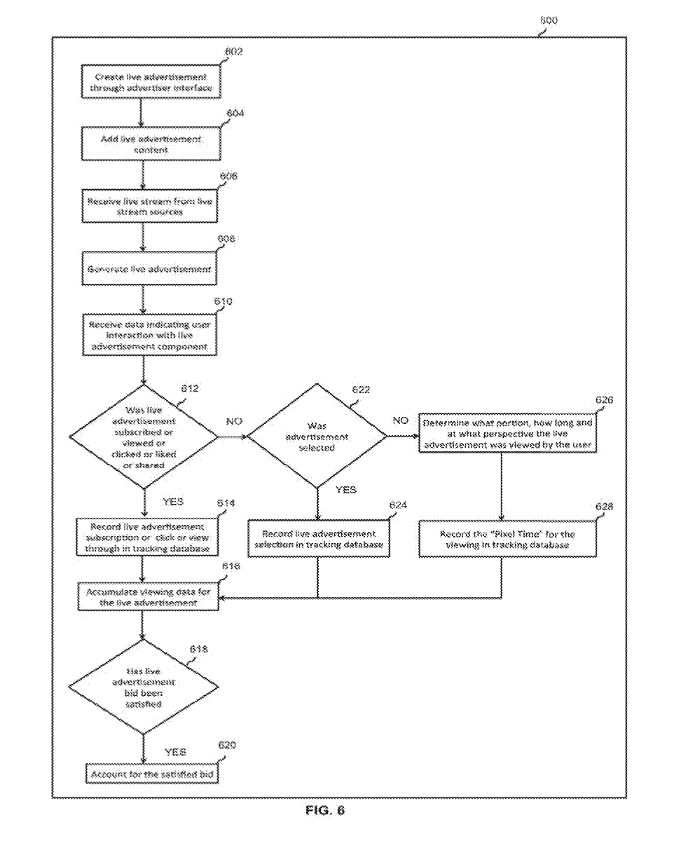

Referring to FIG. 6, process 602 begins with advertiser 102 creating a live advertisement using advertiser interface 304. The advertiser 102 creates advertisement content at (processing block 604) with respect to live advertisement 112. The live streaming server receives live streaming from live streaming sources used by advertiser 102 (processing block 606). The advertising server receives the live stream from live streaming server along with item details and generates (processing block 608) live advertisement 112 for user 114 to be viewed on client devices 116.

The processing logic receiving data indicating a user is interacting with advertisement component (processing block 610). Processing logic determines whether the advertisement has been clicked or viewed or shared or liked by user (processing block 612). When the advertisement has been clicked, processing logic records the advertisement click and/or view in a tracking database (processing block 614). When an advertisement has not been clicked, processing logic determines whether the advertisement was selected (processing block 622). When the advertisement is selected, processing logic records advertisement selection in the tracking database (processing block 624). When an advertisement has not been selected, processing logic determines what portion, how long, and what perspective the advertisement was viewed by the user (processing block 626). The pixel time for the viewing is recorded in the tracking database (processing block 628). Recording a pixel time enables processing logic to factor in conditions unique to viewing advertisements. Processing logic accumulates viewing data for the advertisement (processing block 616). A determination of whether a bid for an advertisement has been satisfied is made (processing block 618). When the bid is not satisfied, based on the accumulated tracking data, processing logic returns to processing block 610 to receive additional data indicating user interaction with a advertisement. When the bid is satisfied, processing logic accounts for the satisfied bid (processing block 620). As discussed above, processing logic accounts for advertisements by debiting advertisers for placing advertisements.

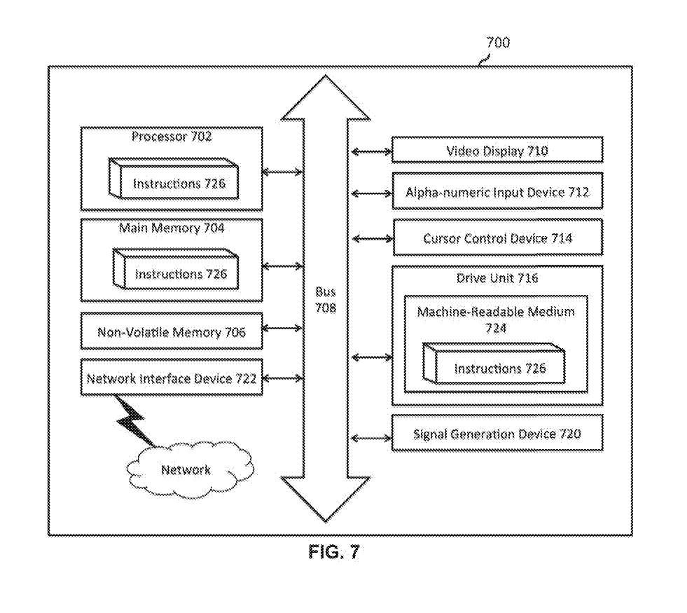

FIG. 7 shows a diagrammatic representation of machine in the exemplary form of a computer system 700 within which a set of instructions, for causing the machine to perform any one of the methodologies discussed above, may be executed. The computer system 700 includes a processor 702, a main memory 704 and a non-volatile memory 706, which communicate with each other via a bus 708. The computer system 700 may further include a video display unit 710 (e.g., a liquid crystal display (LCD) or a cathode ray tube (CRT) or client devices as described in 116A-N of FIG. 1. The computer system 700 also includes an alphanumeric input device 712 (e.g. a keyboard), a cursor control device 714 (e.g. a mouse), a disk drive unit 716, a signal generation device 720 (e.g., a speaker) and a network interface device 722. The disk drive unit 716 includes a machine-readable medium 724 on which is stored a set of instructions (i.e., software) 726 embodying any one, or all, of the methodologies described above. The software 726 is also shown to reside, completely or at least partially, within the main memory 704 and/or within the processor 702. The software 726 may further be transmitted or received via the network interface device 722. For the purposes of this specification, the term “computer-readable medium” shall be taken to include any medium that is capable of storing or encoding a sequence of instructions for execution by the machine and that cause the machine to perform any one of the methodologies of the present invention.

The term “computer-readable medium” shall accordingly be taken to include, but not be limited to, solid-state memories, and optical and magnetic disks. In the foregoing specification, the invention has been described with reference to specific exemplary embodiments thereof. It will, however, be evident that various modifications and changes may be made thereto without departing from the broader spirit and scope of the invention as set forth. The specification and drawings are, accordingly, to be regarded in an illustrative rather than a restrictive sense.

The terminology used herein is for the purpose of describing particular embodiments only and is not intended to be limiting of the invention. As used herein, the singular forms “a embodiment,” “an embodiment,” “the embodiment,” and “another embodiment” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

### REFERENCES CITED

Invention Title—Serving Live Stream As Advertisement
Application Number—WO2015170215
Invention Title—Pre—Fetch Ads While Serving Ads In A Live Stream
Application Number—U.S. Pat. No. 8,566,867
Invention Title—Systems And Methods For Providing And Updating Live-Streaming Online
Content In An Interactive Web Platform
Application Number—U.S. Ser. No. 13/735,927
Invention Title—Live Ad Processing Engine Service
Application Number—US 20140316899
Invention Title—Live Advertising
Application Number—WO 2010110774

What is claimed is:

1. An electronic communication device implemented method of providing advertisement on a network, comprising:
receive live stream data from live streaming sources
the live stream source captures the live stream and transcodes it to live stream module
the transcoded live stream data is stored in a file system inside the live stream module to be streamed through live streaming server
the live streaming server packs the live stream with advertiser ID and the transfers it to ad server which adds the advertiser content based on advertiser ad
the live ads are then shown to user using their client devices
the ad units are shown to user based on user targeting criteria selected by advertiser
user can also subscribe to live ads and receives a notification before start

2. The method of claim 1 wherein the user is able to view only one part of the live advertisement or video stream streamed by the advertiser with the other part being inaccessible or inactive or blurred or non-clickable or time locked as determined and controlled by advertiser.

3. The method of claim 1 wherein a user may reserve a space in a live advertisement in order to return at a later point in time.

4. The method of claim 1 wherein the advertiser has the ability to limit the number of users viewing the live advertisement or allow users to ask questions and/or queries during the live advertisement and limit and/or disable the interaction between users and/or advertiser.

5. The method of claim 1 wherein the advertiser may provide user with details, specifications, images, videos or a combination thereof of at least one item during live advertisement which will be displayed to the user on their electronic communication device.

6. The method of claim 1 wherein the advertiser may record a transcript and/or caption of live advertisement during and/or after and is accessible to the user through an interface on their electronic communication device.

7. The method of claim 1 wherein the ad content module stores live advertisement metadata received from the advertiser which a user can post or access or share on social media with other users or any combination thereof when viewing a live advertisement.

8. The method of claim 1 wherein an ad commerce module is used to conduct e-commerce transactions which include information such as the name, description, and price of the item being advertised, tax rules describing how to tax sales of the item in one or more jurisdictions, postal code serviceability, shipping cost to user, shipment tracking, etc.

9. The method of claim 1 wherein an advertiser can setup a live advertisement to promote one or more items for which a user can make payment for one or more items within the live advertisement for the advertised item without taking them outside of the live advertisement environment.

10. The method of claim 1 wherein an ad generation module generates live advertisement for advertiser by combining live stream module, which contains live streaming of audio and/or video along with ad content module, before showing it to user.

11. The method of claim 1 wherein an ad targeting module defines targeting criteria such as age, gender, geography, user interests, day part timings, dwell times, preferences for live advertisement.

12. The method of claim 1 wherein an advertiser rating module calculates reputation scores indicating the relative qualities of the advertiser by allowing users to provide feedback on their experiences with the advertiser within the live advertisement.

13. The method of claim 1 wherein in the event of live advertisement not starting it will be added to user live advertisement subscription list and will be notified before the start of live advertisement through notifications.

14. The method of claim 1 wherein user can view the number of known users who have also subscribed for live advertisement along with the total number of users who have subscribed for live advertisement.

15. The method of claim 1 wherein a user may indicate to the advertiser that another user to whom the advertisement was sent has chosen not to view the live advertisement.

16. The method of claim 1 wherein advertiser can send invite to those users for live advertisement who have previously viewed the said live advertisement and sent notification to user prior to the start of live advertisement.

17. The method of claim 1 wherein live advertisements show the number of user who are currently watching live advertisement and the timer shows elapsed time since the start of the live advertisement.

18. The method of claim 1 wherein a user is able to view live streaming of audio and/or video by advertiser in miniature mode while browsing item details through the next navigation screen inside the live advertisement and/or embedded web browser and/or in app browser and a comment box is adjustable with drag and drop functionality for user and a user can minimize the comment box to perform actions.
